(19) United States
(12) Patent Application Publication
(10) Pub. No.: US 2026/0167759 A1
(43) Pub. Date: Jun. 18, 2026

(54) DIENE COUPLED COPOLYMERS RICH IN ETHYLENE UNITS AND PREPARATION METHOD THEREOF

(71) Applicant: Compagnie Generale Des Etablissements Michelin, Clermont-Ferrand (FR)

(72) Inventors: Robert NGO, Clermont-Ferrand (FR); François JEAN-BAPTISTE-DIT-DOMINIQUE, Clermont-Ferrand (FR); Karine VERNAY, Clermont-Ferrand (FR)

(73) Assignee: Compagnie Generale Des Etablissements Michelin, Clermont-Ferrand (FR)

(21) Appl. No.: 19/126,437

(22) PCT Filed: Oct. 12, 2023
(86) PCT No.: PCT/EP2023/078332

§ 371 Date: May 1, 2025

(30) Foreign Application Priority Data
Nov. 2, 2022 (FR) 2211398

(51) Int. Cl. C08F 283/12; C08F 4/54; C08F 4/6592; C08F 210/18

(52) U.S. Cl. CPC C08F 283/12; C08F 4/545; C08F 4/65927; C08F 210/18; C08L 2666/04; C08L 2666/06

(57) ABSTRACT

A copolymer of a 1,3-diene and of an olefin which contains more than 50 mol % of ethylene units is provided. The olefin is ethylene or a mixture of ethylene and of an α-monoolefin. The copolymer is a coupled copolymer, and the chains of the copolymer are connected to one another by a group containing at least two units of formula 1, —(CH₂—CH(CH₃)—CO—O)—. Each copolymer chain is bonded to a distinct unit of formula 1 via a covalent bond between a carbon atom of a monomer unit of the copolymer chain and the carbon atom of the methylene group of the unit of formula 1.

### CROSS REFERENCE TO RELATED APPLICATIONS

This U.S. patent application is a national phase entry of PCT Patent Application No. PCT/EP2023/078332, filed Oct. 12, 2023, which claims priority to French Patent Application No. FR 2211398, filed Nov. 2, 2022, the entire contents of which are incorporated herein by reference in their entirety.

### BACKGROUND

### 1. Technical Field

The field of the invention is that of polymers rich in ethylene units and containing units of a 1,3-diene.

### 2. Related Art

Diene polymers rich in ethylene units are known, for example, from Patent Applications WO 2007054223 and WO 2007054224. Such copolymers are, for example, intended to be used in a tire tread. The high molar content of ethylene units in these copolymers, which is greater than 50%, makes these copolymers less sensitive to oxidation phenomena than the diene polymers conventionally used in rubber compositions, which are polybutadienes, polyisoprenes and copolymers of butadiene and of styrene.

It has been found that these copolymers containing units of a 1,3-diene and more than 50 mol % of ethylene units have a tendency to flow under their own weight. This cold flow is not controlled and can pose difficulties in the use of these copolymers, in particular during their storage in the form of balls or in storage boxes. To overcome this problem, it has been proposed, in Patent Application WO 2021/123592, to branch the copolymer chain during its growth in the polymerization reaction. There still exists a need to provide other processes capable of preparing new copolymers rich in ethylene units which contain units of a 1,3-diene and which have a lower propensity to flow.

### SUMMARY

Continuing its efforts to overcome these problems of flow on storage, the Applicant Company has developed new coupled copolymers by virtue of the use, in their process of preparation, of a coupling agent comprising at least two methacrylate functions.

Thus, a first subject-matter of the invention is a copolymer of a 1,3-diene and of an olefin, the olefin being ethylene or a mixture of ethylene and of an α-monoolefin, which copolymer contains more than 50 mol % of ethylene units and is a coupled copolymer, the chains of the copolymer being connected to one another by a group containing at least two units of formula 1

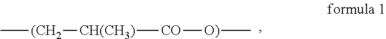

each copolymer chain being bonded to a distinct unit of formula 1 via a covalent bond between a carbon atom of a monomer unit of the copolymer chain and the carbon atom of the methylene group of the unit of formula 1.

A second subject-matter of the invention is a process for the preparation of a coupled copolymer of a 1,3-diene and of an olefin, the copolymer containing more than 50 mol % of ethylene units, which process comprises the successive stages a), b) and c),
stage a) being the polymerization of a monomer mixture containing a 1,3-diene and an olefin in the presence of a catalytic system based at least on a metallocene of formula (Ia) and on an organomagnesium compound, cocatalyst,

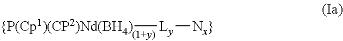

Cp¹ and Cp², which are identical or different, being selected from the group consisting of fluorenyl groups, cyclopentadienyl groups and indenyl groups, the groups being substituted or unsubstituted,
P being a group bridging the two groups Cp¹ and Cp², and comprising a silicon or carbon atom, Nd denoting the neodymium atom,
L representing an alkali metal selected from the group consisting of lithium, sodium and potassium,
N representing a molecule of an ether,
x, which is or is not an integer, being equal to or greater than 0,
y, which is an integer, being equal to or greater than 0,
the olefin being ethylene or a mixture of ethylene and of an α-monoolefin,
stage b) being the reaction of a coupling agent, a compound containing at least two methacrylate functions of formula CH₂═C(CH₃)CO—O—, with the reaction product of the polymerization of stage a),
stage c) being a chain termination reaction.

A third subject-matter of the invention is a polymer composition which contains a copolymer having 2 arms and a copolymer having 3 arms which are in accordance with the invention or which are capable of being obtained by the process in accordance with the invention.

### DETAILED DESCRIPTION

Any interval of values denoted by the expression “between a and b” represents the range of values greater than “a” and less than “b” (that is to say, limits a and b excluded), whereas any interval of values denoted by the expression “from a to b” means the range of values extending from “a” up to “b” (that is to say, including the strict limits a and b).

The compounds mentioned in the description can be of fossil origin or be biobased. In the latter case, they can partially or completely result from biomass or be obtained from renewable raw materials resulting from biomass. In the same way, the compounds mentioned can also originate from the recycling of pre-used materials, that is to say that they can, partially or completely, result from a recycling process, or else be obtained, partially or completely, from starting materials which themselves result from a recycling process.

The expression “based on” used to define the constituents of the catalytic system is understood to mean the mixture of these constituents, or the product of the reaction of a portion or of all of these constituents with one another.

The copolymer in accordance with the invention has the essential characteristic of being a copolymer of a 1,3-diene and of an olefin. The olefin is ethylene or a mixture of ethylene and of an α-monoolefin. The constituent units of the copolymer are those which result from the polymerization of the 1,3-diene and of the olefin. In the case where the olefin is ethylene, the constituent units are those resulting from the polymerization of the 1,3-diene and of ethylene and the copolymer is a copolymer of ethylene and of a 1,3-diene. In the case where the olefin is a mixture of ethylene and an α-monoolefin, the constituent units are those resulting from the polymerization of the 1,3-diene, of ethylene and of the α-monoolefin and the copolymer is a copolymer of ethylene, of a 1,3-diene and of an α-monoolefin. Preferably, the α-monoolefin is styrene.

The copolymer also has the essential characteristic of containing more than 50 mol % of ethylene units. The copolymer preferentially contains more than 60 mol % of ethylene units, more preferentially more than 65 mol % of ethylene units. The copolymer preferentially contains less than 90 mol % of ethylene units, more preferentially at most 85 mol % of ethylene units, more preferentially still at most 80 mol % of ethylene units. The contents of ethylene units in the copolymer are expressed with respect to all of the units resulting from the polymerization of the 1,3-diene and of the olefin.

The 1,3-diene is a single compound, that is to say a single (one) 1,3-diene, or a mixture of 1,3-dienes which differ from one another in the chemical structure. In particular, 1,3-dienes having from 4 to 20 carbon atoms are suitable as 1,3-diene.

Preferably, the 1,3-diene is 1,3-butadiene, isoprene, myrcene, @3-farnesene or their mixtures, such as a mixture of at least two of them. The mixture of at least two of them is advantageously a mixture which contains 1,3-butadiene.

According to a specific embodiment of the invention, the 1,3-diene is a mixture of 1,3-dienes which contains 1,3-butadiene.

According to another particularly preferential embodiment of the invention, the copolymer in accordance with the invention contains 1,3-butadiene units and cyclic units, 1,2-cyclohexane units. The 1,2-cyclohexane units are of formula (I). The cyclic units result from a specific insertion of ethylene and 1,3-butadiene monomers into the polymer chain, in addition to the conventional ethylene and 1,3-butadiene units, respectively —(CH₂—CH₂)—, —(CH₂—CH═CH—CH₂)— and —(CH₂—CH(C═CH₂))—. The mechanism for obtaining such a microstructure is, for example, described in the document Macromolecules, 2009, 42, 3774-3779.

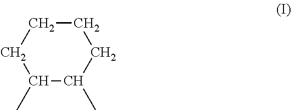

When the copolymer in accordance with the invention contains 1,2-cyclohexane units, it preferentially contains at most 15 mol % thereof, the percentage being expressed with respect to all of the units resulting from the polymerization of the 1,3-diene and of the olefin. Such a copolymer can be prepared by the process in accordance with the invention according to the mode in which the metallocene of the catalytic system has, as ligand, two substituted or unsubstituted fluorenyl groups.

Preferably, the copolymer in accordance with the invention is a copolymer of ethylene and of a 1,3-diene, in which case the constituent monomer units of the copolymer are those resulting from the copolymerization of the ethylene and of the 1,3-diene. Very preferentially, the copolymer in accordance with the invention is a copolymer of ethylene and of 1,3-butadiene or a copolymer of ethylene, of 1,3-butadiene and of myrcene or also a copolymer of ethylene, of 1,3-butadiene and of β-farnesene.

According to any one of the embodiments of the invention, the copolymer in accordance with the invention is preferentially a statistical copolymer. In other words, the constituent monomer units of the copolymer chains (or arms) of the statistical copolymer in accordance with the invention are distributed statistically in the copolymer chains. Such a copolymer can be prepared by the process in accordance with the invention according to the mode in which the polymerization reaction is carried out at constant pressure of monomers in a reactor and a continuous addition of each of the monomers or of one of them is carried out in the reactor. Advantageously, the copolymer in accordance with the invention is a statistical copolymer of ethylene and of 1,3-butadiene or a statistical copolymer of ethylene, of 1,3-butadiene and of myrcene or also a statistical copolymer of ethylene, of 1,3-butadiene and of β-farnesene.

The copolymer in accordance with the invention also has another characteristic of being coupled. The constituent copolymer chains of the copolymer in accordance with the invention are connected to one another by a group containing at least two units of formula 1

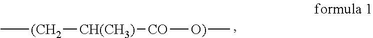

each copolymer chain being bonded to a distinct unit of formula 1 via a covalent bond between a carbon atom of a monomer unit of the copolymer chain and the carbon atom of the methylene group of the unit of formula 1. In other words, the group which connects the copolymer chains to one another can be represented by the following formula: Z′—[O—CO—CH(CH₃)—CH₂—]ᵥ—, Z′ being a group of valency v and v being an integer at least equal to 2, preferably ranging from 2 to 3. Preferably, the copolymer in accordance with the invention is a coupled copolymer having 2 arms or having 3 arms.

According to a preferential embodiment of the invention, the coupled copolymer is a coupled copolymer having 2 arms, the two constituent copolymer chains of the coupled copolymer being connected together by a group containing two units of formula 1. The coupled copolymer having 2 arms preferentially corresponds to the formula 2

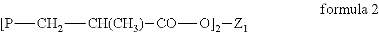

P denoting a copolymer chain,
Z₁ representing a divalent hydrocarbon group or a divalent hydrocarbon group which contains one or more functions chosen from the ether function and the thioether function, it being possible for the divalent group to be substituted by one or more methacrylate functions of

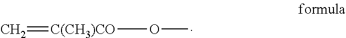

According to first variant, the coupled copolymer having 2 arms corresponds to the formula 2

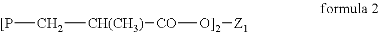

P denoting a copolymer chain,
Z₁ representing a divalent hydrocarbon group or a divalent hydrocarbon group which contains one or more functions chosen from the ether function and the thioether function.

A hydrocarbon group which contains one or more functions chosen from the ether function and the thioether function is understood to mean a hydrocarbon chain which is interrupted by one or more oxygen or sulfur atoms to respectively form ether or thioether bonds.

Advantageously, Z₁ is an acyclic group. Z₁ can be a linear or branched group. The number of carbon atoms in Z₁ is not limited per se. Z₁ can contain up to 20 carbon atoms. Preferably, Z₁ is an alkanediyl or an alkanediyl which contains one or more ether functions. Preferentially, the alkanediyl of Z₁ contains from 1 to 10 carbon atoms, more preferentially from 2 to 8 carbon atoms. Suitable in particular as alkanediyl groups of Z₁ are the 1,2-ethanediyl, 1,1-ethanediyl, 1,3-propanediyl, 1,2-propanediyl, 1,4-butanediyl, 1,3-butanediyl, 1,5-pentanediyl, 2,2-dimethyl-1,3-propanediyl, 1,6-hexanediyl, 2,5-hexanediyl, 1,4-cyclohexanediyl and 1,4-cyclohexanediyldimethylene groups. Also suitable are divalent groups, preferentially alkanediyl groups, interrupted by one or more oxygen atoms to form ether bonds, such as the divalent groups of formula —(CH₂—CH₂-0), —CH₂—CH₂— or —(CH₂—CH₂—CH₂-0), —CH₂—CH₂—CH₂— in which n is an integer greater than or equal to 1, in particular ranging from 1 to 10, more particularly ranging from 1 to 2.

According to a second variant, the coupled copolymer having 2 arms is of formula 2 in which the divalent hydrocarbon group of Z₁ is additionally substituted by one or more methacrylate functions of formula CH₂═C(CH₃)CO—O—, preferentially by one methacrylate function of formula CH₂═C(CH₃)CO—O—. According to the second variant, Z₁ is preferentially an alkanediyl substituted by a methacrylate function.

Advantageously, in the formula 2, Z₁ is an alkanediyl or an alkanediyl substituted by a methacrylate function.

According to another preferential embodiment of the invention, the coupled copolymer is a coupled copolymer having 3 arms, the three constituent copolymer chains of the coupled copolymer being connected together by a group containing three units of formula 1. Preferably, the coupled copolymer having 3 arms corresponds to the formula 3

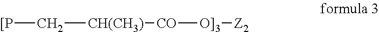

P denoting a copolymer chain,
Z₂ representing a trivalent hydrocarbon group or a trivalent hydrocarbon group which contains one or more functions chosen from the ether function and the thioether function.
Advantageously, Z₂ is an acyclic group. Z₂ can be a linear or branched group. The number of carbon atoms in Z₂ is not limited per se. Z₂ can contain up to 20 carbon atoms. Preferably, Z₂ is an alkanetriyl or an alkanetriyl which contains one or more ether functions. An alkanetriyl is typically a saturated trivalent aliphatic hydrocarbon group. Preferentially, the alkanetriyl of Z₂ contains from 3 to 10 carbon atoms, more preferentially from 3 to 8 carbon atoms.

Suitable in particular as alkanetriyl groups of Z₂ are the propane-1,2,3-triyl, 2-methylpropane-1,2,3-triyl, 2-ethylpropane-1,2,3-triyl, propane-1,1,1-triyltrimethylene and 1,2,5-pentanetriyl groups.

Also suitable are trivalent groups, preferentially alkanetriyl groups, containing oxyalkylene chains, such as oxyethylene or oxypropylene chains, or polyoxyalkylene chains, such as polyoxyethylene or polyoxypropylene chains.
Mention may be made of the propane-1,2,3-triyl, 2-methylpropane-1,2,3-triyl, 2-ethylpropane-1,2,3-triyl or propane-1,1,1-triyltrimethylene groups containing one or more oxyalkylene or polyoxyalkylene chains, in particular oxyethylene or polyoxyethylene chains.
Suitable, for example, are the propane-1,2,3-triyl, 2-methylpropane-1,2,3-triyl or 2-ethylpropane-1,2,3-triyl groups containing three oxyethylene or polyoxyethylene chains in the 1,2,3 positions or the propane-1,1,1-triyltrimethylene group containing three oxyethylene or polyoxyethylene chains in the 1,1,1 positions. The figures of such groups, in which n, m and p are integers greater than or equal to 1, in particular ranging from 1 to 10, more particularly ranging from 1 to 2, are represented below.

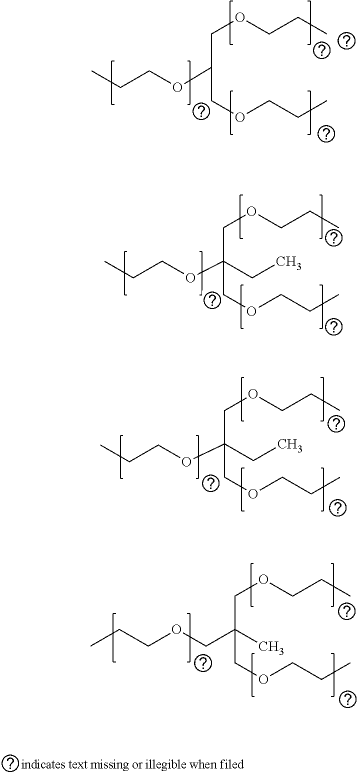

Also suitable are, for example, alkanetriyl groups containing an w-alkoxypoly(oxyalkylene) group, such as an w-methoxypoly(oxyethylene) group. Mention may be made, as such, of the 2-(w-methoxypoly(oxyethylene))propane-1,2,3-triyl and 1-(methoxypoly(oxyalkylene))methane-1,1,1-triyltrimethylene groups.

Advantageously, in the formula (3), Z₂ represents an alkanetriyl.

According to any one of the embodiments, the copolymer in accordance with the invention is preferentially an elastomer and is intended to be used in a rubber composition. In particular, the coupled copolymer having 2 arms and the coupled copolymer having 3 arms are preferentially elastomers.

A coupled copolymer having 3 arms in accordance with the invention is particularly preferred, since it exhibits an advantageous compromise between its macrostructure and its rheological, in particular viscosity, properties compared with a non-coupled copolymer, a polymer having a single arm, or a coupled copolymer having 2 arms, the arms of the non-coupled copolymer and of the coupled copolymer having 2 arms being substantially identical in composition and in length to the arms of the coupled copolymer having 3 arms.

A polymer composition, a mixture containing a coupled copolymer having 2 arms and a coupled copolymer having 3 arms which are in accordance with the invention, is particularly preferred, since it also exhibits improved rheological properties compared with a non-coupled copolymer or a coupled copolymer having 2 arms, the arms of the non-coupled copolymer and of the coupled copolymer having 2 arms being substantially identical in composition and in length to the arms of the coupled copolymer having 3 arms.

A mixture containing a coupled copolymer having 2 arms and a coupled copolymer having 3 arms which are in accordance with the invention and which are both elastomers is also very particularly preferred.

The copolymer in accordance with the invention can be prepared by a process, another subject-matter of the invention, which comprises the successive stages a), b) and c),
stage a) being the polymerization of a monomer mixture containing a 1,3-diene and an olefin in the presence of a catalytic system based at least on a metallocene of formula (Ia) and on an organomagnesium compound

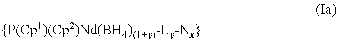

Cp¹ and Cp², which are identical or different, being selected from the group consisting of fluorenyl groups, cyclopentadienyl groups and indenyl groups, the groups being substituted or unsubstituted,
P being a group bridging the two groups Cp¹ and Cp² and comprising a silicon or carbon atom,
Nd denoting the neodymium atom,
L representing an alkali metal selected from the group consisting of lithium, sodium and potassium,
N representing a molecule of an ether,
x, which is or is not an integer, being equal to or greater than 0,
y, which is an integer, being equal to or greater than 0,
the olefin being ethylene or a mixture of ethylene and of an α-monoolefin,
stage b) being the reaction of a coupling agent, a compound containing at least two methacrylate functions of formula CH₂═C(CH₃)CO—O—, with the reaction product of the polymerization of stage a),
stage c) being a chain termination reaction.

Stage a) of the process in accordance with the invention is a polymerization reaction of a monomer mixture of a 1,3-diene and of an olefin which makes it possible to prepare the copolymer chains of a 1,3-diene and of an olefin, growing chains intended to react in the following stage, stage b), with a coupling agent.

The 1,3-diene of the monomer mixture of stage a) is a single compound, that is to say a single (one) 1,3-diene, or a mixture of 1,3-dienes which differ from one another in the chemical structure. Suitable in particular as 1,3-diene are 1,3-dienes having from 4 to 20 carbon atoms, such as 1,3-butadiene, isoprene, myrcene, β-farnesene and their mixtures. The 1,3-diene is preferably 1,3-butadiene, isoprene, myrcene, β-farnesene or their mixtures, in particular a mixture of at least two of them. More preferentially, the 1,3-diene is 1,3-butadiene or a mixture of 1,3-dienes which contains 1,3-butadiene which is preferentially a mixture of 1,3-butadiene and of myrcene or a mixture of 1,3-butadiene and of β-farnesene.

According to a first variant of the invention, the olefin of the monomer mixture of stage a) is ethylene. According to this variant, the monomer mixture is a mixture of a 1,3-diene and of ethylene and the reaction product of the polymerization of stage a) is a polymer chain, the constituent units of which result from the insertion of ethylene and of 1,3-diene in the growing chain. The copolymer prepared by this first variant is a copolymer of ethylene and of a 1,3-diene.

According to a second variant of the invention, the monomer mixture of stage a) is a mixture of a 1,3-diene and of an olefin which is itself a mixture of ethylene and of an α-monoolefin. According to this variant, the reaction product of the polymerization of stage a) is a polymer chain, the constituent units of which result from the insertion of ethylene, of the α-monoolefin and of 1,3-diene in the growing chain. The α-monoolefin is preferentially styrene or a styrene, the benzene ring of which is substituted by alkyl groups, more preferentially styrene. The copolymer prepared by a preferential embodiment of the second variant is a copolymer of ethylene, of a 1,3-diene and of styrene.

Preferably, the monomer mixture of stage a) contains more than 50 mol % of ethylene, the percentage being expressed with respect to the total number of moles of monomers of the monomer mixture of stage a). When the monomer mixture contains an α-monoolefin, such as styrene, it preferentially contains less than 40 mol % of the α-monoolefin, the percentage being expressed with respect to the total number of moles of monomers of the monomer mixture of stage a).

The copolymerization of the monomer mixture can be carried out in accordance with Patent Applications WO 2007054223 A2 and WO 2007054224 A2 using a catalytic system composed of a metallocene and an organomagnesium compound.

In the present patent application, metallocene is understood to mean an organometallic complex, the metal of which, in the case in point the neodymium atom, is bonded to a molecule referred to as ligand and consisting of two Cp¹ and Cp² groups connected together by a bridge P. These Cp¹ and Cp² groups, which are identical or different, are selected from the group consisting of fluorenyl groups, cyclopentadienyl groups and indenyl groups, it being possible for these groups to be substituted or unsubstituted.

According to the invention, the metallocene used as base constituent in the catalytic system corresponds to the formula (Ia)

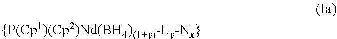

P being a group bridging the two groups Cp¹ and Cp² and comprising a silicon or carbon atom,
Cp¹ and Cp², which are identical or different, being selected from the group consisting of fluorenyl groups, cyclopentadienyl groups and indenyl groups, the groups being substituted or unsubstituted,
Nd denoting the neodymium atom,
L representing an alkali metal selected from the group consisting of lithium, sodium and potassium
N representing a molecule of an ether,
x, which is or is not an integer, being equal to or greater than 0,
y, which is an integer, being equal to or greater than 0.

Any ether which has the ability to complex the alkali metal, in particular diethyl ether, methyltetrahydrofuran and tetrahydrofuran, is suitable as ether.

Mention may be made, as substituted cyclopentadienyl, fluorenyl and indenyl groups, of those substituted by alkyl radicals having from 1 to 6 carbon atoms or by aryl radicals having from 6 to 12 carbon atoms or also by trialkylsilyl radicals, such as SiMe₃ radicals. The choice of the radicals is also guided by the accessibility to the corresponding molecules, which are the substituted cyclopentadienes, fluorenes and indenes, because these are commercially available or can be easily synthesized.

Mention may be made, as substituted fluorenyl groups, of those substituted in the 2, 7, 3 or 6 position, particularly 2,7-di(tert-butyl)fluorenyl or 3,6-di(tert-butyl)fluorenyl. The 2, 3, 6 and 7 positions respectively denote the positions of the carbon atoms of the rings as represented in the diagram below, position 9 corresponding to the carbon atom to which the bridge P is attached.

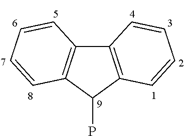

Mention may be made, as substituted cyclopentadienyl groups, of those substituted equally well in the 2 (or 5) position as in the 3 (or 4) position, particularly those substituted in the 2 position, more particularly the tetramethylcyclopentadienyl group. The 2 (or 5) position denotes the position of the carbon atom which is adjacent to the carbon atom to which the bridge P is attached, as represented in the diagram below. It is recalled that a substitution in the 2 or 5 position is also denoted substitution in the α position with respect to the bridge.

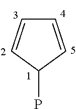

Mention may in particular be made, as substituted indenyl groups, of those substituted in the 2 position, more particularly 2-methylindenyl or 2-phenylindenyl. The 2 position denotes the position of the carbon atom which is adjacent to the carbon atom to which the bridge P is attached, as represented in the diagram below.

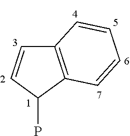

Preferably, Cp¹ and Cp², which are identical or different, are cyclopentadienyls substituted in the α position with respect to the bridge, substituted fluorenyls, substituted indenyls or fluorenyl of formula C₁₃H₈ or else indenyl of formula C₉H₇. More preferentially, Cp¹ and Cp², which are identical or different, are selected from the group consisting of substituted fluorenyl groups and the unsubstituted fluorenyl group of formula C₁₃H₈. Advantageously, Cp¹ and Cp² are identical and each represent an unsubstituted fluorenyl group of formula C₁₃H₈, represented by the symbol Flu.

Preferably, the bridge P connecting the groups Cp¹ and Cp² is of formula ZR¹R², in which Z represents a silicon or carbon atom and R¹ and R², which are identical or different, each represent an alkyl group comprising from 1 to 20 carbon atoms, preferably a methyl. In the formula ZR¹R², Z advantageously represents a silicon atom, Si.

Better still, the metallocene is of formula (I-1), (I-2), (I-3), (I-4) or (I-5):

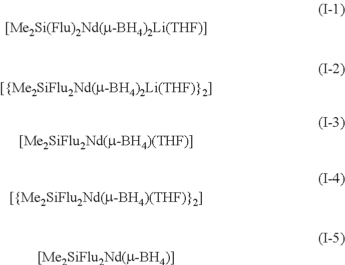

in which Flu represents the C₁₃H₈ group.

The metallocene of use in the synthesis of the catalytic system can be in the form of a crystalline or non-crystalline powder, or also in the form of single crystals. The metallocene can be provided in a monomeric or dimeric form, these forms depending on the method of preparation of the metallocene, such as, for example, that described in Patent Application WO 2007054224 A2 or WO 2007054223 A2. The metallocene can be prepared conventionally by a process analogous to that described in Patent Application WO 2007054224 A2 or WO 2007054223 A2, in particular by reaction, under inert and anhydrous conditions, of the salt of an alkali metal of the ligand with a borohydride of the rare earth metal neodymium in a suitable solvent, such as an ether, for example diethyl ether or tetrahydrofuran, or any other solvent known to a person skilled in the art. After reaction, the metallocene is separated from the reaction by-products by techniques known to a person skilled in the art, such as filtration or precipitation from a second solvent. The metallocene is finally dried and isolated in solid form.

The organomagnesium compound, the other base constituent of the catalytic system, is the co-catalyst of the catalytic system. Typically, the organomagnesium compound can be a diorganomagnesium compound or a halide of an organomagnesium compound. Preferably, the organomagnesium compound is of formula (IIa), (IIb), (IIc) or (Ild) in which R³, R⁴, R⁵ and R^{B}, which are identical or different, represent a carbon-comprising group, R^{A} represents a divalent carbon-comprising group, X is a halogen atom and m is a number greater than or equal to 1, preferably equal to 1.

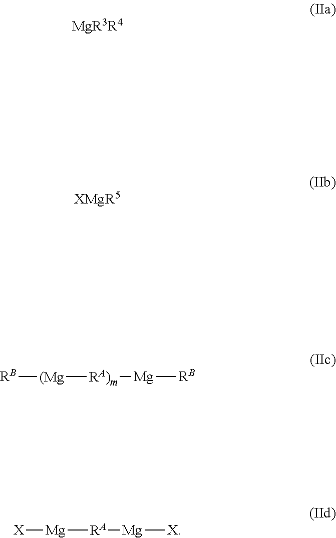

R^{A} can be a divalent aliphatic hydrocarbon chain, interrupted or not interrupted by one or more oxygen or sulfur atoms or else by one or more arylene groups.

Carbon-comprising group is understood to mean a group which contains one or more carbon atoms. The carbon-comprising group can be a hydrocarbon group (hydrocarbyl group) or else a heterohydrocarbon group, that is to say a group comprising, in addition to the carbon and hydrogen atoms, one or more heteroatoms. The compounds described as transfer agents in Patent Application WO2016092227 A1 may be suitable as organomagnesium compounds having a heterohydrocarbon group. The carbon-comprising groups represented by the symbols R³, R⁴, R⁵, R^{B} and R^{A} are preferentially hydrocarbon groups.

Preferably, R^{A} contains from 3 to 10 carbon atoms, in particular from 3 to 8 carbon atoms.

Preferably, R^{A} is a divalent hydrocarbon chain. Preferably, R^{A} is a linear or branched alkanediyl, a cycloalkanediyl or a xylenediyl radical. More preferentially, R^{A} is an alkanediyl. More preferentially still, R^{A} is an alkanediyl having from 3 to 10 carbon atoms. Advantageously, R^{A} is an alkanediyl having from 3 to 8 carbon atoms. Very advantageously, R^{A} is a linear alkanediyl. Very particularly suitable as R^{A} group are 1,3-propanediyl, 1,4-butanediyl, 1,5-pentanediyl, 1,6-hexanediyl, 1,7-heptanediyl and 1,8-octanediyl.

The carbon-comprising groups represented by R³, R⁴, R⁵ and R^{B} can be aliphatic or aromatic.

They can contain one or more heteroatoms, such as an oxygen, nitrogen, silicon or sulfur atom.

Preferably, they are alkyls, phenyls or aryls. They can contain from 1 to 20 carbon atoms.

The alkyls represented by R³, R⁴, R⁵ and R^{B} can contain from 2 to 10 carbon atoms and are in particular ethyl, butyl or octyl.

The aryls represented by R³, R⁴, R⁵ and R^{B} can contain from 7 to 20 carbon atoms and are in particular a phenyl substituted by one or more alkyls, such as methyl, ethyl or isopropyl.

R³, R⁴ and R⁵ are preferentially alkyls containing from 2 to 10 carbon atoms, phenyls or aryls containing from 7 to 20 carbon atoms.

According to a specific embodiment of the invention, R³ comprises a benzene nucleus substituted by a magnesium atom, one of the carbon atoms of the benzene nucleus ortho to the magnesium being substituted by a methyl, an ethyl or an isopropyl or forming a ring with the carbon atom which is its closest neighbour and which is meta to the magnesium, the other carbon atom of the benzene nucleus ortho to the magnesium being substituted by a methyl, an ethyl or an isopropyl, and R⁴ is an alkyl. According to this specific embodiment, R³ is advantageously 1,3-dimethylphenyl, 1,3-diethylphenyl, mesityl or 1,3,5-triethylphenyl and R⁴ is advantageously ethyl, butyl or octyl.

According to another specific embodiment of the invention, R³ and R⁴ are alkyls containing from 2 to 10 carbon atoms, in particular ethyl, butyl or octyl.

Preferably, R⁵ is an alkyl containing from 2 to 10 carbon atoms, in particular ethyl, butyl or octyl.

Advantageously, R^{B} comprises a benzene nucleus substituted by the magnesium atom, one of the carbon atoms of the benzene nucleus ortho to the magnesium being substituted by a methyl, an ethyl or an isopropyl or forming a ring with the carbon atom which is its closest neighbour and which is meta to the magnesium, the other carbon atom of the benzene nucleus ortho to the magnesium being substituted by a methyl, an ethyl or an isopropyl. Better still, R^{B} is 1,3-dimethylphenyl, 1,3-diethylphenyl, mesityl or 1,3,5-triethylphenyl.

Suitable as organomagnesium compound are, for example, butylethylmagnesium, butyloctylmagnesium, ethylmagnesium chloride, butylmagnesium chloride, ethylmagnesium bromide, butylmagnesium bromide, octylmagnesium chloride, octylmagnesium bromide, 1,3-dimethylphenylbutylmagnesium, 1,3-diethylphenylethylmagnesium, butylmesitylmagnesium, ethylmesitylmagnesium, 1,3-diethylphenylbutylmagnesium, 1,3-diethylphenylethylmagnesium, 1,3-diisopropylphenylbutylmagnesium, 1,3-diisopropylphenylethylmagnesium, 1,3,5-triethylphenylbutylmagnesium, 1,3,5-triethylphenylethylmagnesium, 1,3,5-triisopropylphenylbutylmagnesium, 1,3,5-triisopropylphenylethylmagnesium, 1,3-propanediylbis(magnesium bromide), 1,3-propanediylbis(magnesium chloride), 1,5-pentanediylbis(magnesium bromide), 1,5-pentanediylbis(magnesium chloride), 1,8-octanediylbis(magnesium bromide) and 1,8-octanediylbis(magnesium chloride).

The organomagnesium compound of formula (IIc) can be prepared by a process which comprises the reaction of a first organomagnesium compound of formula X′Mg—R^{A}—MgX′ with a second organomagnesium compound of formula R^{B}—Mg—X′, X′ representing a halogen atom, preferentially a bromine or chlorine atom, and R^{B} and R^{A} being as defined above. X′ is more preferentially a bromine atom. The stoichiometry used in the reaction determines the value of m in formula (IIc). For example, a molar ratio of 0.5 of the amount of the first organomagnesium compound to the amount of the second organomagnesium compound is favourable to the formation of an organomagnesium compound of formula (IIc) in which m is equal to 1, whereas a molar ratio of greater than 0.5 will be more favourable to the formation of an organomagnesium compound of formula (IIc) in which m is greater than 1.

To carry out the reaction of the first organomagnesium compound with the second organomagnesium compound, a solution of the second organomagnesium compound is typically added to a solution of the first organomagnesium compound. The solutions of the first organomagnesium compound and of the second organomagnesium compound are generally solutions in an ether, such as diethyl ether, dibutyl ether, tetrahydrofuran, methyltetrahydrofuran or the mixture of two or more of these ethers. Preferably, the respective concentrations of the solutions of the first organomagnesium compound and of the second organomagnesium compound are from 0.01 to 3 mol/1 and from 0.02 to 5 mol/1 respectively. More preferentially, the respective concentrations of the first organomagnesium compound and of the second organomagnesium compound are from 0.1 to 2 mol/l and from 0.2 to 4 mol/l respectively.

The first organomagnesium compound and the second organomagnesium compound can be prepared beforehand by a Grignard reaction starting from magnesium metal and from a suitable precursor in a reactor. For the first organomagnesium compound and the second organomagnesium compound, the respective precursors are of formulae X′—R^{A}—X′ and R^{B}—X′, R^{A}, R^{B} and X′ being as defined above. The Grignard reaction is typically carried out by the addition of the precursor to magnesium metal, which is generally provided in the form of turnings. Preferably, iodine (I₂), typically in the bead form, is introduced into the reactor before the addition of the precursor in order to activate the Grignard reaction in a known way.

Alternatively, the organomagnesium compound of formula (IIc) can be prepared by reaction of an organometallic compound of formula M-R^{A}-M and of the organomagnesium compound of formula R^{B}—Mg—X′, M representing a lithium, sodium or potassium atom and X′, R^{B} and R^{A} being as defined above. Preferably, M represents a lithium atom, in which case the organometallic compound of formula M-R^{A}-M is an organolithium compound.

The reaction of the organolithium compound and of the organomagnesium compound is typically carried out in an ether, such as diethyl ether, dibutyl ether, tetrahydrofuran or methyltetrahydrofuran, methylcyclohexane, toluene or their mixture. The reaction is also typically carried out at a temperature ranging from 0° C. to 60° C. The operation of bringing into contact is preferably carried out at a temperature of between 0° C. and 23° C. The operation of bringing the organometallic compound of formula M-R^{A}-M into contact with the organomagnesium compound of formula R^{B}—Mg—X′ is preferentially carried out by the addition of a solution of the organometallic compound M-R^{A}-M to a solution of the organomagnesium compound R^{B}—Mg—X′. The solution of the organometallic compound M-R^{A}-M is generally a solution in a hydrocarbon solvent, preferably n-hexane, cyclohexane or methylcyclohexane, and the solution of the organomagnesium compound R^{B}—Mg—X′ is generally a solution in an ether, preferably diethyl ether or dibutyl ether. Preferably, the respective concentrations of the solutions of the organometallic compound and of the organomagnesium compound M-R^{A}-M and R^{B}—Mg—X′ are from 0.01 to 1 mol/l and from 0.02 to 5 mol/l respectively. More preferentially, the respective concentrations of the solutions of the organometallic compound and of the organomagnesium compound M-R^{A}-M and R^{B}—Mg—X′ are from 0.05 to 0.5 mol/l and from 0.2 to 3 mol/l respectively.

Like any synthesis carried out in the presence of organometallic compounds, the syntheses described for the synthesis of the organomagnesium compounds take place under anhydrous conditions under an inert atmosphere, in stirred reactors. Typically, the solvents and the solutions are used under anhydrous nitrogen or argon.

Once the organomagnesium compound of formula (IIc) has been formed, it is generally recovered in solution after filtration carried out under an inert and anhydrous atmosphere. It can be stored before its use in its solution in sealed containers, for example capped bottles, at a temperature of between −25° C. and 23° C.

The compounds of formula (IId), which are Grignard reagents, are described, for example, in the work “Advanced Organic Chemistry” by J. March, 4^{th} Edition, 1992, pages 622-623, or in the work “Handbook of Grignard Reagents”, edited by Gary S. Silverman and Philip E. Rakita, 1996, pages 502-503. They can be synthesized by bringing magnesium metal into contact with a dihalogenated compound of formula X—R^{A}—X, R^{A} being as defined according to the invention. For their synthesis, reference may be made, for example, to the collection of volumes of “Organic Synthesis”.

The compounds of formulae (Ila) and (Ild), which are also Grignard reagents, are well known; some of them are even commercial products. For their synthesis, reference may also be made, for example, to the collection of volumes of “Organic Synthesis”.

Like any organomagnesium compound, the organomagnesium compound constituting the catalytic system, in particular of formula (IIa), (IIb), (IIc) or (Ild), can be provided in the form of a monomer entity or in the form of a polymer entity. By way of illustration, the organomagnesium compound (IIc) can be provided in the form of a monomer entity (R^{B}—(Mg—R^{A})ₘ—Mg—R^{B})₁ or in the form of a polymer entity (R^{B}—(Mg—R^{A})ₘ—Mg—R^{B})ₚ, p being an integer greater than 1, in particular a dimer (R^{B}—(Mg—R^{A})ₘ—Mg—R^{B})₂, m being as defined above. In the same way, also by way of illustration, the organomagnesium compound of formula (IId) can be provided in the form of a monomer entity (X—Mg—R^{A}—Mg—X)₁ or in the form of a polymer entity (X—Mg—R^{A}—Mg—X)ₚ, p being an integer greater than 1, in particular a dimer (X—Mg—R^{A}—Mg—X)₂.

Moreover, whether it is in the form of a monomer or polymer entity, the organomagnesium compound can also be provided in the form of an entity coordinated with one or more molecules of a solvent, preferably of an ether, such as diethyl ether, tetrahydrofuran or methyltetrahydrofuran.

In the formulae (IIb) and (IId), X is preferentially a bromine or chlorine atom, more preferentially a bromine atom.

According to any one of the embodiments of the invention, the organomagnesium compound is preferably of formula (IIa).

The amounts of co-catalyst and of metallocene reacted are such that the ratio of the number of moles of Mg of the co-catalyst to the number of moles of the rare earth metal of the metallocene, neodymium, preferably ranges from 0.5 to 200, more preferentially from 1 to less than 20. The range of values extending from 1 to less than 20 is in particular more favourable for obtaining copolymers of high molar masses.

According to a first embodiment, the catalytic system can be prepared conventionally by a process analogous to that described in Patent Application WO 2007054224 A2 or WO 2007054223 A2. For example, the co-catalyst, in the case in point the organomagnesium compound, and the metallocene are reacted in a hydrocarbon solvent typically at a temperature ranging from 20° C. to 80° C. for a period of time of between 5 and 60 minutes. The catalytic system is generally prepared in an aliphatic hydrocarbon solvent, such as methylcyclohexane, or an aromatic hydrocarbon solvent, such as toluene, preferably in an aliphatic hydrocarbon solvent, such as methylcyclohexane. Generally, after its synthesis, the catalytic system is used in this form for stage a).

According to a second embodiment, the catalytic system can be prepared by a process analogous to that described in Patent Application WO 2017093654 A1 or in Patent Application WO 2018020122 A1: it is said to be of preformed type. For example, the organomagnesium compound and the metallocene are reacted in a hydrocarbon solvent typically at a temperature of from 20° C. to 80° C. for 10 to 20 minutes, in order to obtain a first reaction product, and a preformation monomer is then reacted with this first reaction product at a temperature ranging from 40° C. to 90° C. for 1 h to 12 h. The preformation monomer is preferably used according to a (preformation monomer/metal of the metallocene) molar ratio ranging from 5 to 1000, preferentially from 10 to 500. Before its use in polymerization, the catalyst system of preformed type can be stored under an inert atmosphere, in particular at a temperature ranging from −20° C. to ambient temperature (23° C.). According to this second embodiment, the catalytic system of preformed type has as base constituent a preformation monomer chosen from 1,3-dienes, ethylene and their mixtures. In other words, the “preformed” catalytic system contains, besides the metallocene and the co-catalyst, a preformation monomer. The 1,3-diene, as preformation monomer, can be 1,3-butadiene, isoprene or also a 1,3-diene of formula CH₂═CR⁶—CH═CH₂, the symbol R⁶ representing a hydrocarbon group having from 3 to 20 carbon atoms, in particular myrcene or β-farnesene. The preformation monomer is preferentially 1,3-butadiene.

The catalytic system is typically provided in a solvent which is preferentially the solvent in which it was prepared, and the concentration of rare earth metal, that is to say of neodymium, of metallocene is then within a range extending preferentially from 0.0001 to 0.2 mol/l, more preferentially from 0.001 to 0.03 mol/l.

Like any synthesis carried out in the presence of an organometallic compound, the synthesis of the metallocene, the synthesis of the organomagnesium compound and the synthesis of the catalytic system take place under anhydrous conditions under an inert atmosphere. Typically, the reactions are carried out starting from anhydrous solvents and compounds under anhydrous nitrogen or argon.

The polymerization of the monomer mixture is carried out in a reactor, preferably in solution, continuously or non-continuously. The polymerization solvent is typically a hydrocarbon solvent, preferably an aliphatic hydrocarbon solvent. Methylcyclohexane is very particularly suitable as an example of an aliphatic hydrocarbon solvent. The monomer mixture can be introduced into the reactor containing the polymerization solvent and the catalytic system or, conversely, the catalytic system can be introduced into the reactor containing the polymerization solvent and the monomer mixture. The monomer mixture and the catalytic system can be introduced simultaneously into the reactor containing the polymerization solvent, in particular in the case of a continuous polymerization. The polymerization is typically carried out under anhydrous conditions and in the absence of oxygen, in the optional presence of an inert gas. The polymerization temperature generally varies within a range extending from 40° C. to 150° C., preferentially from 40° C. to 120° C. A person skilled in the art adapts the polymerization conditions, such as the polymerization temperature, the concentration of each of the reactants or the pressure in the reactor, according to the composition of the monomer mixture, the polymerization reactor, and the microstructure and the macrostructure which are desired for the copolymer chain.

The polymerization is preferentially carried out at a constant pressure of monomers. A continuous addition of each of the monomers or of one of them can be carried out in the polymerization reactor, in which case the polymerization reactor is a fed reactor. This embodiment is very particularly suitable for a statistical incorporation of the monomers. Preferably, the polymerization of stage a) is a statistical polymerization, which is reflected by a statistical incorporation of the monomers of the monomer mixture which is used in stage a).

Once the desired degree of conversion of the monomers is reached in the polymerization reaction of stage a), stage b) is carried out.

Stage b) of the process in accordance with the invention brings together the reaction product of stage a) and a coupling agent, a compound containing at least two methacrylate functions of formula CH₂═C(CH₃)CO—O—. Stage b) is a coupling reaction of the copolymer chains, one of the ends of which reacts with the coupling agent without there being subsequent polymerization of the methacrylate functions. After deactivation of the reactive sites by a termination reaction of the polymer chain (stage c), there is obtained a coupled copolymer of a 1,3-diene and of an olefin, the chains of the copolymer being connected to one another by a group containing at least two units of formula 1

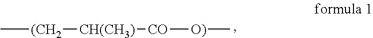

each copolymer chain being bonded to a distinct unit of formula 1 via a covalent bond between a carbon atom of the terminal monomer unit of the copolymer chain and the carbon atom of the methylene group of the unit of formula 1. The terminal monomer unit is typically the constituent monomer unit of the chain end of the copolymer, which unit is obtained on conclusion of stage a), which reacts with the coupling agent.

The methacrylates of use for the requirements of the invention as coupling agent can be bismethacrylates or trismethacrylates. They can be commercial products. These are preferentially commercially available products. When the methacrylates are packaged in the presence of a stabilizer, as is the case for most commercial methacrylates, they are typically used after removal of the stabilizer, which can be carried out in a well-known manner by distillation or by treatment on alumina columns.

According to a first preferential embodiment of the invention, the coupling agent is a bismethacrylate, which compound contains two methacrylate functions, preferentially of formula 3

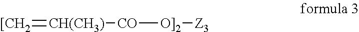

Z₃ representing a divalent hydrocarbon group or a divalent hydrocarbon group substituted by one or more functions chosen from the ether function and the thioether function. Advantageously, Z₃ is an acyclic group. Z₃ can be a linear or branched group. The number of carbon atoms in Z₃ is not limited per se. Z₃ can contain up to 20 carbon atoms. Preferably, Z₃ is an alkanediyl or an alkanediyl substituted by one or more ether functions, more preferentially an alkanediyl. Preferentially, the alkanediyl of Z₃ contains from 1 to 10 carbon atoms, more preferentially from 2 to 8 carbon atoms. Suitable in particular as alkanediyl groups of Z₃ are the 1,2-ethanediyl, 1,1-ethanediyl, 1,3-propanediyl, 1,2-propanediyl, 1,4-butanediyl, 1,3-butanediyl, 1,5-pentanediyl, 2,2-dimethyl-1,3-propanediyl, 1,6-hexanediyl, 2,5-hexanediyl, 1,4-cyclohexanediyl and 1,4-cyclohexanediyldimethylene groups. Also suitable are divalent hydrocarbon groups, preferentially alkanediyl groups, interrupted by one or more oxygen atoms to form ether bonds, such as the divalent groups of formulae —(CH₂—CH₂—O)ₙ—CH₂—CH₂— and —(CH₂—CH₂—CH₂—O)ₙ—CH₂—CH₂—CH₂— in which n is an integer greater than or equal to 1, in particular ranging from 1 to 10, more particularly ranging from 1 to 2. By way of illustration of bismethacrylates containing polyoxyalkylene chains, mention may be made of triethylene glycol dimethacrylate, dipropylene glycol dimethacrylate, neopentyl glycol propoxylate dimethacrylate or bisphenol A ethoxylate dimethacrylate.
For reasons of commercial availability, the coupling agent is advantageously diethylene glycol dimethacrylate, triethylene glycol dimethacrylate, thiodi-2,1-ethanediyl bismethacrylate, ethylidene dimethacrylate, 1,2-propanediol dimethacrylate, 1,3-propanediol dimethacrylate, 1,3-butanediol dimethacrylate, 1,4-butanediol dimethacrylate, neopentyl glycol dimethacrylate, 1,4-cyclohexanediol dimethacrylate or cyclohexane-1,4-dimethanol dimethacrylate, more advantageously diethylene glycol dimethacrylate, triethylene glycol dimethacrylate, ethylidene dimethacrylate, 1,2-propanediol dimethacrylate, 1,3-propanediol dimethacrylate, 1,3-butanediol dimethacrylate, 1,4-butanediol dimethacrylate or neopentyl glycol dimethacrylate, more advantageously still ethylidene dimethacrylate, 1,2-propanediol dimethacrylate, 1,3-propanediol dimethacrylate, 1,3-butanediol dimethacrylate, 1,4-butanediol dimethacrylate or neopentyl glycol dimethacrylate.

According to a second preferential embodiment of the invention, the coupling agent is a trismethacrylate, which compound contains three methacrylate functions, preferentially of formula 4

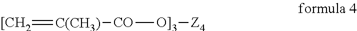

Z₄ representing a trivalent hydrocarbon group or a trivalent hydrocarbon group substituted by one or more functions chosen from the ether function and the thioether function. Advantageously, Z₄ is an acyclic group. Z₄ can be a linear or branched group. The number of carbon atoms in Z₄ is not limited per se. Z₄ can contain up to 20 carbon atoms. Preferably, Z₄ is an alkanetriyl or an alkanetriyl substituted by one or more ether functions, more preferentially an alkanetriyl. An alkanetriyl is typically a saturated trivalent aliphatic hydrocarbon group.
Preferentially, the alkanetriyl of Z₄ contains from 3 to 10 carbon atoms, more preferentially from 3 to 8 carbon atoms.
Suitable in particular as alkanetriyl groups of Z₄ are the propane-1,2,3-triyl, 2-methylpropane-1,2,3-triyl, 2-ethylpropane-1,2,3-triyl, propane-1,1,1-triyltrimethylene and 1,2,5-pentanetriyl groups.
Also suitable are trivalent groups, preferentially alkanetriyl groups, containing oxyalkylene chains, such as oxyethylene or oxypropylene chains, or polyoxyalkylene chains, such as polyoxyethylene or polyoxypropylene chains.
Mention may be made of the propane-1,2,3-triyl, 2-methylpropane-1,2,3-triyl, 2-ethylpropane-1,2,3-triyl or propane-1,1,1-triyltrimethylene groups containing one or more oxyalkylene or polyoxyalkylene chains, in particular oxyethylene or polyoxyethylene chains.
Suitable, for example, are the propane-1,2,3-triyl, 2-methylpropane-1,2,3-triyl or 2-ethylpropane-1,2,3-triyl groups containing three oxyethylene or polyoxyethylene chains in the 1,2,3 positions or the propane-1,1,1-triyltrimethylene group containing three oxyethylene or polyoxyethylene chains in the 1,1,1 positions. The figures of such groups, in which n, m and p are integers greater than or equal to 1, in particular ranging from 1 to 10, more particularly ranging from 1 to 2, are represented below.

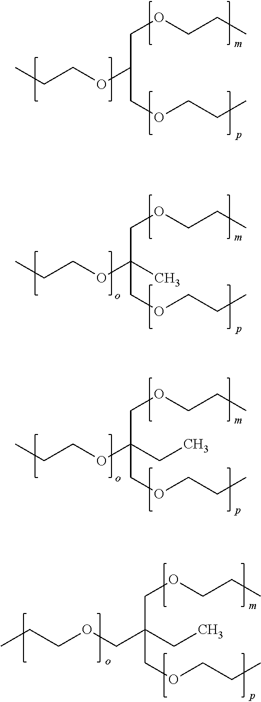

Also suitable are, for example, alkanetriyl groups containing an ω-alkoxypoly(oxyalkylene) group, such as an w-methoxypoly(oxyethylene) group. Mention may be made, as such, of the 2-(ω-methoxypoly(oxyethylene))propane-1,2,3-triyl and 1-(methoxypoly(oxyalkylene))methane-1,1,1-triyltrimethylene groups.

For reasons of commercial availability, the coupling agent is advantageously glycerol trimethacrylate, also known under the name of propane-1,2,3-triyl tris(2-methylacrylate), 1,1,1-trimethylolpropane trimethacrylate or 1,2,5-pentanetriyl trismethacrylate.

Preferably, stage b) is carried out in an aliphatic hydrocarbon solvent, such as methylcyclohexane. Advantageously, it is carried out in the reaction medium resulting from stage a). It is generally carried out by the addition of the coupling agent to the reaction product from stage a) in its reaction medium with stirring.

Before the addition of the coupling agent, the reactor is preferably degassed and inerted. The degassing of the reactor makes it possible to remove the gaseous residual monomers and also facilitates the addition of the coupling agent to the reactor. Alternatively, the coupling agent can be injected by excess pressure into the reactor. The inerting of the reactor, for example with nitrogen, makes it possible not to deactivate the carbon-metal bonds present in the reaction medium and necessary for the coupling reaction of the copolymer chains. The coupling agent can be added pure or diluted in a hydrocarbon solvent, preferably an aliphatic hydrocarbon solvent, such as methylcyclohexane, or an aromatic hydrocarbon solvent, such as toluene. The coupling agent is left in contact with the reaction product from stage a) for the time necessary for the coupling reaction. The coupling reaction can typically be monitored by chromatographic analysis in order to monitor the consumption of the coupling agent. The coupling reaction is preferentially carried out at a temperature ranging from 23° C. to 120° C., for 1 to 60 minutes, under stirring. The coupling reaction is preferentially carried out with one molar equivalent of methacrylate function with respect to the number of carbon-magnesium bonds per mole of co-catalyst of the catalytic system. The ratio of the number of molar equivalents of methacrylate function to the number of carbon-magnesium bonds per mole of co-catalyst can, however, vary according to the desired content of coupled polymer in the polymer obtained on conclusion of stage c), according to the desired number of arms in the coupled copolymer and, in the case of the production of a mixture of coupled copolymers having a different number of arms, according to their respective proportions. A ratio close to 1, typically ranging from 0.85 to 1.05, promotes the highest degrees of coupling. Advantageously, stage b), the coupling reaction, is carried out with a ratio of the number of molar equivalents of methacrylate function to the number of carbon-magnesium bonds per mole of co-catalyst varying from 0.85 to 1.5. Typically, in a diorganomagnesium compound, such as butyloctylmagnesium (BOMAG), there are two carbon-magnesium bonds per mole of the magnesium compound. One mole of a compound having two methacrylate functions is equivalent to two molar equivalents of methacrylate function; more generally, one mole of a compound having n methacrylate functions is equivalent to n molar equivalents of methacrylate function, n being an integer of greater than or equal to 2.

Once the chain end has been modified, stage b) is followed by stage c).

Stage c), the chain termination reaction, is typically a reaction which makes it possible to deactivate the reactive sites still present in the reaction medium resulting from stage b). In stage c), a chain-terminating agent is brought into contact with the reaction product from stage b), generally in its reaction medium, for example by adding the terminating agent to the reaction medium on conclusion of stage b) or by pouring the reaction medium obtained on conclusion of stage b) onto a solution containing the terminating agent. The terminating agent is generally in stoichiometric excess. The terminating agent is typically a protic compound, a compound which comprises a relatively acidic proton. Mention may be made, by way of terminating agent, of water, carboxylic acids, in particular C₂-C₁₈ fatty acids, such as acetic acid or stearic acid, aliphatic or aromatic alcohols, such as methanol, ethanol or isopropanol, or phenolic antioxidants.

After reaction with a protic compound, the process results in a coupled copolymer in accordance with the invention. The copolymer prepared according to the process in accordance with the invention can be separated from the reaction medium of stage c) according to processes well known to a person skilled in the art, for example by an operation of evaporation of the solvent under reduced pressure or by a steam stripping operation.

The process having recourse to a coupling agent having two methacrylate functions preferentially results in the preparation of a coupled copolymer having 2 arms, whereas the process having recourse to a coupling agent having three methacrylate functions preferentially results in the preparation of a coupled copolymer having 3 arms or in the preparation of a mixture containing a coupled copolymer having 2 arms and a coupled copolymer having 3 arms.

The process in accordance with the invention exhibits the advantage of resulting in the preparation of a coupled copolymer without there being polymerization of the methacrylate functions, which is reflected by the absence of the formation of polymethacrylate, both in the block polymer form and in the homopolymer form. Consequently, the coupled copolymer in accordance with the invention is obtained without being contaminated by polymethacrylate, whether this is in the form of block copolymers or of homopolymers.

To sum up, the invention can be implemented according to any one of the following embodiments 1 to 52:

Embodiment 1: Copolymer of a 1,3-diene and of an olefin, the olefin being ethylene or a mixture of ethylene and of an α-monoolefin, which copolymer contains more than 50 mol % of ethylene units and is a coupled copolymer, the chains of the copolymer being connected to one another by a group containing at least two units of formula 1

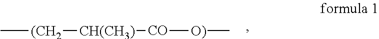

each copolymer chain being bonded to a distinct unit of formula 1 via a covalent bond between a carbon atom of a monomer unit of the copolymer chain and the carbon atom of the methylene group of the unit of formula 1.

Embodiment 2: Copolymer according to Embodiment 1, which copolymer is a coupled copolymer having 2 arms or having 3 arms.

Embodiment 3: Copolymer according to Embodiment 1 or 2, which copolymer corresponds to the formula 2

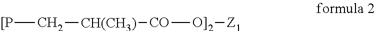

P denoting a copolymer chain,
Z₁ representing a divalent hydrocarbon group or a divalent hydrocarbon group which contains one or more functions chosen from the ether function and the thioether function.

Embodiment 4: Copolymer according to Embodiment 3, in which Z₁ is an alkanediyl or an alkanediyl which contains one or more ether functions.

Embodiment 5: Copolymer according to Embodiment 3 or 4, in which Z₁ is an alkanediyl.

Embodiment 6: Copolymer according to Embodiment 4 or 5, in which the alkanediyl of Z₁ contains from 1 to 10 carbon atoms.

Embodiment 7: Copolymer according to any one of Embodiments 4 to 6, in which the alkanediyl of Z₁ is the 1,2-ethanediyl, 1,1-ethanediyl, 1,3-propanediyl, 1,2-propanediyl, 1,4-butanediyl, 1,3-butanediyl, 1,5-pentanediyl, 2,2-dimethyl-1,3-propanediyl, 1,6-hexanediyl, 2,5-hexanediyl, 1,4-cyclohexanediyl or 1,4-cyclohexanediyldimethylene group.

Embodiment 8: Copolymer according to any one of Embodiments 3 to 7, in which the divalent hydrocarbon group of Z₁ is additionally substituted by one or more methacrylate functions of formula CH₂═C(CH₃)CO—O—.

Embodiment 9: Copolymer according to Embodiment 8, in which Z₁ is an alkanediyl substituted by a methacrylate function.

Embodiment 10: Copolymer according to Embodiment 1 or 2, which copolymer corresponds to the formula 3

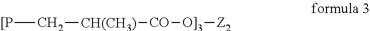

P denoting a copolymer chain,
Z₂ representing a trivalent hydrocarbon group or a trivalent hydrocarbon group which contains one or more functions chosen from the ether function and the thioether function.

Embodiment 11: Copolymer according to Embodiment 10, in which Z₂ is an alkanetriyl or an alkanetriyl which contains one or more ether functions.

Embodiment 12: Copolymer according to Embodiment 11, in which the alkanetriyl of Z₂ contains from 3 to 10 carbon atoms.

Embodiment 13: Copolymer according to any one of Embodiments 10 to 12, in which Z₂ is an alkanetriyl.

Embodiment 14: Copolymer according to any one of Embodiments 10 to 13, in which the alkanetriyl of Z₂ is the propane-1,2,3-triyl, 2-methylpropane-1,2,3-triyl, 2-ethylpropane-1,2,3-triyl, propane-1,1,1-triyltrimethylene or 1,2,5-pentanetriyl group.

Embodiment 15: Copolymer according to any one of Embodiments 1 to 14, which copolymer contains more than 60 mol % of ethylene units.

Embodiment 16: Copolymer according to any one of Embodiments 1 to 15, which copolymer contains more than 65 mol % of ethylene units.

Embodiment 17: Copolymer according to any one of Embodiments 1 to 16, which copolymer contains less than 90 mol % of ethylene units.

Embodiment 18: Copolymer according to any one of Embodiments 1 to 17, which copolymer contains at most 85 mol % of ethylene units.

Embodiment 19: Copolymer according to any one of Embodiments 1 to 18, which copolymer contains at most 80 mol % of ethylene units.

Embodiment 20: Copolymer according to any one of Embodiments 1 to 19, in which the α-monoolefin is styrene.

Embodiment 21: Copolymer according to any one of Embodiments 1 to 20, which copolymer is a copolymer of ethylene and of a 1,3-diene.

Embodiment 22: Copolymer according to any one of Embodiments 1 to 21, which copolymer is a statistical copolymer.

Embodiment 23: Copolymer according to any one of Embodiments 1 to 22, in which the 1,3-diene is 1,3-butadiene, isoprene, myrcene, β-farnesene or their mixtures.

Embodiment 24: Copolymer according to any one of Embodiments 1 to 23, in which the 1,3-diene is 1,3-butadiene.

Embodiment 25: Copolymer according to any one of Embodiments 1 to 24, in which the 1,3-diene is a mixture of 1,3-dienes which contains 1,3-butadiene.

Embodiment 26: Copolymer according to any one of Embodiments 1 to 25, which copolymer contains 1,3-butadiene units and 1,2-cyclohexane units.

Embodiment 27: Copolymer according to any one of Embodiments 1 to 26, which copolymer contains at most 15 mol % of 1,2-cyclohexane units.

Embodiment 28: Copolymer according to any one of Embodiments 1 to 27, which copolymer is a copolymer of ethylene and of 1,3-butadiene.

Embodiment 29: Copolymer according to any one of Embodiments 1 to 28, which copolymer is a copolymer of ethylene, of 1,3-butadiene and of myrcene.

Embodiment 30: Copolymer according to any one of Embodiments 1 to 29, which copolymer is a copolymer of ethylene, of 1,3-butadiene and of β-farnesene.

Embodiment 31: Copolymer according to any one of Embodiments 1 to 30, which copolymer is an elastomer.

Embodiment 32: Process for the preparation of a coupled copolymer of a 1,3-diene and of an olefin, the copolymer containing more than 50 mol % of ethylene units, which process comprises the successive stages a), b) and c),
stage a) being the polymerization of a monomer mixture containing a 1,3-diene and an olefin in the presence of a catalytic system based at least on a metallocene of formula (Ia) and on an organomagnesium compound, cocatalyst,

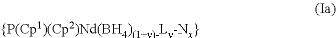

Cp¹ and Cp², which are identical or different, being selected from the group consisting of fluorenyl groups, cyclopentadienyl groups and indenyl groups, the groups being substituted or unsubstituted,
P being a group bridging the two groups Cp¹ and Cp², and comprising a silicon or carbon atom,
Nd denoting the neodymium atom,
L representing an alkali metal selected from the group consisting of lithium, sodium and potassium,
N representing a molecule of an ether,
x, which is or is not an integer, being equal to or greater than 0,
y, which is an integer, being equal to or greater than 0,
the olefin being ethylene or a mixture of ethylene and of an α-monoolefin,
stage b) being the reaction of a coupling agent, a compound containing at least two methacrylate functions of formula CH₂═C(CH₃)CO—O—, with the reaction product of the polymerization of stage a),
stage c) being a chain termination reaction.

Embodiment 33: Process according to Embodiment 32, in which the coupling agent is a bismethacrylate or a trismethacrylate.

Embodiment 34: Process according to Embodiment 32 or 33, in which the coupling agent is of formula 3 or of formula 4

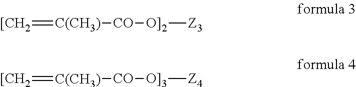

Z₃ representing a divalent hydrocarbon group or a divalent hydrocarbon group substituted by one or more functions selected from the ether function and the thioether function,
Z₄ representing a trivalent hydrocarbon group or a trivalent hydrocarbon group substituted by one or more functions chosen from the ether function and the thioether function.

Embodiment 35: Process according to Embodiment 34, in which Z₃ is an alkanediyl or an alkanediyl substituted by one or more ether functions, preferably an alkanediyl.

Embodiment 36: Process according to Embodiment 34 or 35, in which the alkanediyl of Z₃ contains from 1 to 10 carbon atoms.

Embodiment 37: Process according to any one of Embodiments 32 to 34, in which the coupling agent is diethylene glycol dimethacrylate, triethylene glycol dimethacrylate, ethylidene dimethacrylate, 1,2-propanediol dimethacrylate, 1,3-propanediol dimethacrylate, 1,3-butanediol dimethacrylate, 1,4-butanediol dimethacrylate or neopentyl glycol dimethacrylate.

Embodiment 38: Process according to Embodiment 34, in which Z₄ is an alkanetriyl or an alkanetriyl substituted by one or more ether functions.

Embodiment 39: Process according to Embodiment 34 or 38, in which the alkanetriyl of Z₄ contains from 3 to 10 carbon atoms.

Embodiment 40: Process according to any one of Embodiments 32 to 34, in which the coupling agent is glycerol trimethacrylate, 1,1,1-trimethylolpropane trimethacrylate or 1,2,5-pentanetriyl trismethacrylate.

Embodiment 41: Process according to any one of Embodiments 32 to 40, in which stage b) is carried out with a ratio of the number of molar equivalents of methacrylate function to the number of carbon-magnesium bonds per mole of co-catalyst varying from 0.85 to 1.5.

Embodiment 42: Process according to any one of Embodiments 32 to 41, in which stage b) is carried out in an aliphatic hydrocarbon solvent.

Embodiment 43: Process according to any one of Embodiments 32 to 42, in which the olefin is ethylene.

Embodiment 44: Process according to any one of Embodiments 32 to 43, in which the 1,3-diene is 1,3-butadiene, isoprene, myrcene, β-farnesene or their mixtures.

Embodiment 45: Process according to any one of Embodiments 32 to 44, in which the 1,3-diene is 1,3-butadiene or a mixture of 1,3-dienes which contains 1,3-butadiene which is preferentially a mixture of 1,3-butadiene and of myrcene or a mixture of 1,3-butadiene and of β-farnesene.

Embodiment 46: Process according to any one of Embodiments 32 to 45, in which R¹ and R² each represent a methyl.

Embodiment 47: Process according to any one of Embodiments 32 to 46, in which Z represents a silicon atom.

Embodiment 48: Process according to any one of Embodiments 32 to 47, in which the metallocene is of formula (I-1), (I-2), (I-3), (I-4) or (I-5):

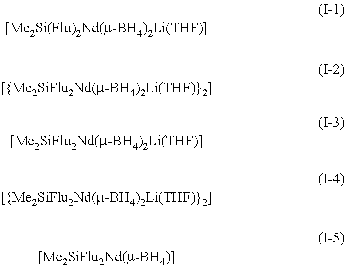

in which Flu represents the C₁₃H₈ group.

Embodiment 49: Process according to any one of Embodiments 32 to 48, in which the organomagnesium compound is of formula (IIa) in which R³ and R⁴, which are identical or different, represent a carbon-comprising group

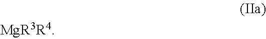

Embodiment 50: Process according to any one of Embodiments 32 to 49, in which R³ and R⁴ are alkyls.

Embodiment 51: Process according to any one of Embodiments 32 to 50, in which R³ and R⁴ are alkyls containing from 2 to 10 carbon atoms.

Embodiment 52: Polymer composition which contains a copolymer having 2 arms and a copolymer having 3 arms, which copolymers are defined in any one of Embodiments 1 to 31 or which are capable of being obtained by a process defined in any one of Embodiments 32 to 51.

A better understanding of the abovementioned characteristics of the present invention, and also others, will be obtained on reading the following description of implementational examples of the invention, which are given by way of illustration.

### Example

### Size Exclusion Chromatography (SEC):

### a) Principle of the Measurement:

Size exclusion chromatography or SEC makes it possible to separate macromolecules in solution according to their size across columns filled with a porous gel. The macromolecules are separated according to their hydrodynamic volume, the bulkiest being eluted first. Combined with three detectors (3D), a refractometer, a viscometer and a 90° light scattering detector, SEC makes it possible to learn the distribution of absolute molar masses of a polymer. The various number-average (Mn) and weight-average (Mw) absolute molar masses and the dispersity ( [symbol] =Mw/Mn) can also be calculated.

### b) Preparation of the Polymer:

Each sample is dissolved in tetrahydrofuran at a concentration of approximately 1 g/l. The solution is then filtered through a filter with a porosity of 0.45 μm before injection.

### c) 3D Sec Analysis:

To determine the number-average molar mass (Mn) and, if appropriate, the weight-average molar mass (Mw) and the polydispersity index (PI or also denoted Ð=Mw/Mn) of the polymers, the method below is used.
The number-average molar mass (Mn), the weight-average molar mass (Mw) and the polydispersity index of the polymer (hereinafter sample) are determined in an absolute way by triple detection size exclusion chromatography (SEC). Triple detection size exclusion chromatography exhibits the advantage of measuring average molar masses directly without calibration.
The value of the refractive index increment dn/dc of the solution of the sample is measured in line using the area of the peak detected by the refractometer (RI) of the liquid chromatography equipment. In order to apply this method, it must be verified that 100% of the sample mass is injected and eluted through the column. The area of the RI peak depends on the concentration of the sample, on the constant of the RI detector and on the value of the dn/dc.
In order to determine the average molar masses, use is made of the 1 g/I solution in tetrahydrofuran previously prepared and filtered, which is injected into the chromatographic line. The apparatus used is a Wyatt chromatographic line. The elution solvent is tetrahydrofuran containing 250 ppm of BHT (2,6-di(tert-butyl)-4-hydroxytoluene), the flow rate is 1 ml·min⁻¹, the temperature of the system is 35° C. and the analytical time is 60 min. The columns used are a set of three Agilent columns of PL Gel Mixed B LS trade name. The volume injected of the solution of the sample is 100 μl. The detection system is composed of a Wyatt differential viscometer of Viscostar II trade name, of a Wyatt differential refractometer of Optilab T-Rex trade name of wavelength 658 nm and of a Wyatt multi-angle static light scattering detector of wavelength 658 nm and of Dawn Heleos 8+ trade name.
For the calculation of the number-average molar masses and the polydispersity index, the value of the refractive index increment dn/dc of the solution of the sample obtained above is integrated. The software for evaluating the chromatographic data is the Astra system from Wyatt.

### Nuclear Magnetic Resonance (NMR):

The copolymers are characterized by ¹H, ¹³C and ²⁹Si NMR spectrometry. The NMR spectra are recorded on a Bruker Avance III HD 500 MHz spectrometer equipped with a BBFO z-grad 5 mm “broad band” cryoprobe. The quantitative ¹H NMR experiment uses a simple 30° pulse sequence and a repetition time of 5 seconds between each acquisition. 64 to 256 accumulations are carried out. The quantitative ¹³C NMR experiment uses a simple 30° pulse sequence with a proton decoupling and a repetition time of 10 seconds between each acquisition. 1024 to 10240 accumulations are carried out. The axis of the ¹H chemical shifts is calibrated with respect to the protonated impurity of the solvent (CDCl₃) at δ_{1H}=7.20 ppm. The axis of the ¹³C chemical shifts is calibrated with respect to the signal of the solvent (CDCl₃) at δ_{13C}=77 ppm.

### Determination of the Glass Transition Temperature of the Polymers:

The glass transition temperature (Tg) is measured by means of a differential scanning calorimeter according to Standard ASTM D3418 (1999).

### Degree of Crystallinity of the Polymers:

Standard ISO 11357-3:2011 is used to determine the temperature and the enthalpy of fusion and of crystallization of the polymers used by differential scanning calorimetry (DSC). The reference enthalpy of polyethylene is 277.1 J/g (according to Polymer Handbook, 4th Edition, J. Brandrup, E. H₈. Immergut and E. A. Grulke, 1999).

### Viscosity:

The dry polymer is redissolved in toluene at 0.1 g/dl. The viscosity measurement is carried out using an Ostwald viscometer immersed in a water bath at 25° C. The temperature of the bath is controlled using a closed-circulation thermal bath.
The viscosity of the polymer is measured in relative terms with respect to the solvent in which it is in solution. The measurement of the viscosity of toluene in the Ostwald viscometer makes it possible to obtain to, an elution time between point A and point B expressed in hundredths of a second.
The viscosity measurement of the polymer in solution in toluene at 0.1 g/dl (C) in the Ostwald viscometer makes it possible to obtain t₁, an elution time between point A and point B expressed in hundredths of a second.
The viscosity of the polymer, expressed in dl/g, is subsequently calculated according to the following formula:

$$visco = 1 / C \times ( {t}_{1} - {t}_{0} ) / {t}_{0} .$$

### Preparation of the Copolymers:

The metallocene [{Me₂SiFlu₂Nd(μ-BH₄)₂Li(THF)}]₂ is prepared according to the procedure described in Patent Application WO 2007054224.

The butyloctylmagnesium BOMAG (20% in heptane, at 0.88 mol·l⁻¹) originates from Chemtura and is stored in a Schlenk tube under an inert atmosphere.
The ethylene, of N35 grade, originates from Air Liquide and is used without prior purification.
The 1,3-butadiene is purified over alumina guards.
The coupling agent is trimethylolpropane trimethacrylate, sold by Sigma-Aldrich. The trismethacrylate is used after purification over alumina guards and after sparging with nitrogen.
The methylcyclohexane (MCH) solvent originating from BioSolve is dried and purified on an alumina column in a solvent purifier originating from mBraun and used under an inert atmosphere.

All the reactions are carried out under an inert atmosphere.

All the polymerizations and the coupling reactions are carried out in a reactor having a disposable 500 ml glass vessel (Schott flasks) equipped with a stainless-steel stirring blade. The temperature is controlled by virtue of a thermostatically-controlled oil bath connected to a polycarbonate jacket. This reactor has all the inlets or outlets necessary for the handling operations.
The co-catalyst and then the metallocene are added to a 500 ml glass reactor containing MCH.
The amount of metallocene introduced is 40 mg and the amount of active BOMAG is 154 μmoles.
The duration of activation is 10 minutes and the reaction temperature is 80° C.
The polymerization is carried out at 80° C. and at an initial pressure of 4 bar absolute in the 500 ml glass reactor containing 300 ml of polymerization solvent, methylcyclohexane, and the catalytic system. The 1,3-butadiene and the ethylene are introduced in the form of a gas mixture containing 20 mol % of 1,3-butadiene.
At the desired conversion, i.e. after the consumption of approximately 10 g of polymer monomers, either procedure A, for the synthesis of non-coupled control copolymer, or procedure B, for the synthesis of coupled copolymers in accordance with the invention, is carried out.

### Procedure A: Synthesis of Non-Coupled Control Copolymer (Example 1)

The polymerization reaction is stopped by the addition of an excess of ethanol with respect to the number of moles of magnesium and of neodymium. The copolymer is recovered by precipitation from methanol and then dried at 60° C. under vacuum under a nitrogen stream.
Procedure B: Synthesis of Coupled Copolymers in Accordance with the Invention (Examples 2 to 5)
The coupling agent is introduced under an inert atmosphere by excess pressure according to a molar content shown in Table 1 and expressed with respect to the number of carbon-magnesium bonds per mole of co-catalyst of the catalytic system, active BOMAG (Coupling agent/C—Mg molar ratio).
The reaction medium is stirred at 80° C. for 60 minutes, then degassed and cooled. After degassing the reactor and cooling, ethanol is introduced into the reaction medium, this being done in excess with respect to the number of moles of magnesium and of neodymium. The reaction medium is subsequently precipitated from methanol and then the polymer recovered is dried at 60° C. under vacuum under a nitrogen stream to constant weight. It is subsequently analysed by SEC (THF) and NMR.

The copolymerization reaction and coupling reaction conditions which are specific to each example, and also the characteristics of the copolymers synthesized, appear in Table 1 and in Table 2. The 3D SEC method was used to determine the number-average and weight-average molar masses, and the microstructure of the polymers was determined by NMR. The content of ethylene units, the content of 1,3-butadiene units in the 1,2-configuration (1,2-units) and in the 1,4-configuration (1,4-units), and the content of 1,2-cyclohexane units (ring units) are expressed as molar percentage with respect to all the monomer units of the copolymer.

The 3D SEC analysis makes it possible to determine the intrinsic viscosity values at each number-average molar mass over the entire distribution of the polymer. From the Mark-Houvink-Sakurada relationship linking the intrinsic viscosity to the number-average molar mass according to the equation ln(visco)=ln(K)+aln(Mn), it is possible to calculate the coefficient α for a polymer population of average molar mass.

It is known to a person skilled in the art that the architecture of a polymer is linked to the coefficient α. If this coefficient decreases, then this indicates that the viscosity of the polymer changes little as a function of its molar mass and that the polymer is structured, that is to say star-branched. The results appear in Table 3.

TABLE 1

| | Coupling | Weight of | | | | | |
|---|---|---|---|---|---|---|---|
| | agent/ | dry | Polymerization | Ethylene | 1,2- | 1,4- | Ring |
| | C—Mg molar | polymer | time | unit | unit | unit | unit |
| Example | ratio | (g) | (h) | (mol %) | (mol %) | (mol %) | (mol %) |
| 1 | 0 | 7 | 1.3 | 78.7 | 3.4 | 6.1 | 12.8 |
| 2 | 0.1 | 11 | 3.3 | 78.3 | 3.6 | 5.5 | 12.5 |
| 3 | 0.3 | 11 | 2.1 | 77.3 | 4.3 | 5.7 | 12.7 |
| 4 | 1 | 9 | 4.3 | 76.4 | 5.2 | 6.1 | 12.3 |
| 5 | 0.1 | 11 | 3.3 | 77.6 | 5.0 | 5.9 | 11.5 |

TABLE 2

| | Mn | Mw | | Visco | Tg/delta T | Crystallinity |
|---|---|---|---|---|---|---|
| Example | (g/mol) | (g/mol) | PDI | (dl/g) | (° C.) | (%) |
| 1 | 46300 | 56100 | 1.2 | 0.79 | −31/6 | 3.5 |
| 2 | 132300 | 225000 | 1.7 | 2.00 | −31/7 | 2.6 |
| 3 | 81800 | 111900 | 1.4 | 1.45 | −31/7 | 2.2 |
| 4 | 143500 | 292200 | 2.0 | 2.09 | −32/7 | 1.7 |
| 5 | 149600 | 283000 | 1.9 | 1.83 | −32/7 | 1.5 |

TABLE 3

| | Architecture | Polymer population | Proportion of coupled |
|---|---|---|---|
| Example | coefficient | (g/mol) | polymers |
| 1 | 0.62 | 32 000-77 000 | |
| 2 | 0.64 | 90 000-208 000 | 62% |
| | 0.49 | 213 000-539 000 | 38% |
| 3 | 0.68 | 55 000-101 000 | 50% |
| | 0.53 | 103 000-266 000 | 50% |

The viscosity values measured using an Ostwald viscometer and displayed in Table 2 show that the polymers synthesized according to Procedure B (reaction with the trismethacrylate coupling agent) have a higher viscosity than their non-coupled control (Example 1) and indicate that the reaction with the coupling agent results in the formation of coupled polymers. The increase in the number-average and weight-average molar masses displayed in Table 2 confirm the formation of coupled chains, in particular having 2 arms and having 3 arms, since the average molar masses have increased by a factor of approximately 2 to 3. The observed increases in viscosity reflect a change in the rheological properties of the polymer compared with its control, a non-coupled polymer. The coupled polymer has a propensity to flow which is less.

The results of Table 3, which result from the working of the Mark-Houvink-Sakurada relationship, show that the reaction with the trismethacrylate coupling agent results in a mixture containing coupled polymers having 2 arms (having architecture coefficients of greater than 0.6) and coupled polymers having 3 arms (star-branched polymers having architecture coefficients of less than 0.6).

It is also noticed that a molar ratio of the number of methacrylate functions to the number of moles of magnesium of close to 1, i.e. a molar ratio of the number of moles of the trismethacrylate coupling agent to the number of carbon-magnesium bonds per mole of cocatalyst of equal to 0.3, is more favourable to the production of a coupled polymer having 3 arms (star-branched polymer).

Finally, as displayed in Table 2, the results of the DSC analysis indicate that each of the copolymers exhibits a single Tg, and also a relatively low delta T value, since it is 6° C. or 7° C. These combined data demonstrate that statistical elastomers are obtained.

What is claimed is:

1. A copolymer, comprising: a 1,3-diene and an olefin, the olefin being ethylene or a mixture of ethylene and an α-monoolefin, wherein the copolymer contains more than 50 mol % of ethylene units and is a coupled copolymer, chains of the copolymer being connected to one another by a group containing at least two units of formula 1 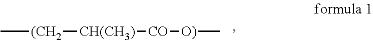
each copolymer chain being bonded to a distinct unit of formula 1 via a covalent bond between a carbon atom of a monomer unit of the copolymer chain and the carbon atom of a methylene group of the unit of formula 1.

2. The copolymer according to claim 1, wherein the copolymer is a coupled copolymer having 2 arms or having 3 arms.

3. The copolymer according to claim 1, wherein the copolymer corresponds to formula 2 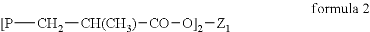
P denoting a copolymer chain,
Z₁ representing a divalent hydrocarbon group or a divalent hydrocarbon group which contains one or more functions chosen from an ether function and a thioether function.

4. The copolymer according to claim 1, wherein the copolymer corresponds to formula 3 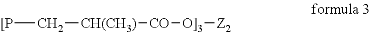
P denoting a copolymer chain,
Z₂ representing a trivalent hydrocarbon group or a trivalent hydrocarbon group which contains one or more functions chosen from an ether function and a thioether function.

5. The copolymer according to claim 3, wherein Z₁ is an alkanediyl or an alkanediyl substituted by a methacrylate function and Z₂ is an alkanetriyl.

6. The copolymer according to claim 1, wherein the copolymer is a copolymer of ethylene and of a 1,3-diene.

7. The copolymer according to claim 1, wherein the copolymer is a statistical copolymer.

8. The copolymer according to claim 1, in which the 1,3-diene is 1,3-butadiene, isoprene, myrcene, β-farnesene or a mixture thereof.

9. The copolymer according to claim 1, wherein the copolymer contains 1,3-butadiene units and 1,2-cyclohexane units of formula (I)

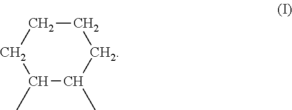

10. The copolymer according to claim 1, wherein the copolymer is an elastomer.

11. A process for preparing a coupled copolymer of a 1,3-diene and of an olefin, the copolymer containing more than 50 mol % of ethylene units, wherein the process comprises successive stages a), b) and c),
stage a) being a polymerization of a monomer mixture containing a 1,3-diene and an olefin in the presence of a catalytic system based at least on a metallocene of formula (Ia) and on an organomagnesium compound, cocatalyst, 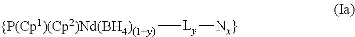
Cp¹ and Cp², which are identical or different, being selected from the group consisting of fluorenyl groups, cyclopentadienyl groups and indenyl groups, the groups being substituted or unsubstituted,
P being a group bridging the two groups Cp¹ and Cp², and comprising a silicon or carbon atom,
Nd denoting the neodymium atom,
L representing an alkali metal selected from the group consisting of lithium, sodium and potassium,
N representing a molecule of an ether,
x, which is or is not an integer, being equal to or greater than 0,
y, which is an integer, being equal to or greater than 0,
the olefin being ethylene or a mixture of ethylene and of an α-monoolefin,
stage b) being the reaction of a coupling agent, a compound containing at least two methacrylate functions of formula CH₂═C(CH₃)CO—O—, with the reaction product of the polymerization of stage a), and
stage c) being a chain termination reaction.

12. The process according to claim 11, in which the coupling agent is a bismethacrylate or a trismethacrylate.

13. The process according to claim 11, in which the coupling agent is of formula 3 or of formula 4 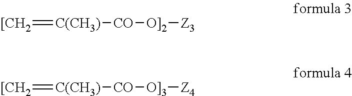
Z₃ representing a divalent hydrocarbon group or a divalent hydrocarbon group substituted by one or more functions selected from an ether function and a thioether function, and
Z₄ representing a trivalent hydrocarbon group or a trivalent hydrocarbon group substituted by one or more functions chosen from the ether function and the thioether function.

14. The process according to claim 11, in which stage b) is carried out in an aliphatic hydrocarbon solvent.

15. A polymer composition which contains a copolymer having 2 arms and a copolymer having 3 arms, wherein the copolymers are defined in claim 1.

16. The copolymer according to claim 4, wherein Z₁ is an alkanediyl or an alkanediyl substituted by a methacrylate function and Z₂ is an alkanetriyl.

17. The copolymer according to claim 4, wherein the divalent group to be substituted by one or more methacrylate functions of formula CH₂═C(CH₃)CO—O—.
